(19) United States
(12) Patent Application Publication
(10) Pub. No.: US 2010/0146042 A1
(43) Pub. Date: Jun. 10, 2010

(54) INTERACTIVE CUSTOMIZABLE BROADCAST

(76) Inventors: Douglas Paul Kruhoeffer, Eden Prairie, MN (US); Douglas John Williams, Orono, MN (US)

Correspondence Address: SIMMONS PERRINE MOYER BERGMAN PLC, CITY CENTER SQUARE, 1100 - 5th Street Suite 205, CORALVILLE, IA, 52241, US

(21) Appl. No.: 12/514,856

(22) PCT Filed: May 9, 2008
(86) PCT No.: PCT/US08/63198

§ 371 Date: Sep. 16, 2009

Related U.S. Application Data
(60) Provisional application No. 60/938,386, filed on May 16, 2007.
(60) Provisional application No. 60/930,637, filed on May 17, 2007.

(51) Int. Cl. G06F 15/16

(52) U.S. Cl. 709/203

(57) ABSTRACT

The present invention concerns an interactive customizable broadcast which is characterized by the ability of the user to select those individual broadcast stories or materials offered by a broadcaster (content provider) that are of particular interest to the user for assembly into a customized broadcast that is played immediately or at a later time. The customized broadcast may be supported by advertising which is also selected by the user from a menu of choices provided by the broadcaster. The broadcast may also be interactive providing the user with the ability to provide feedback to the broadcaster or the ability of the user to explore related or additional material to the offerings selected by the user. The interactive customizable broadcast service is also a smart service which is capable of learning the categorical preferences of the user for content and advertising.

### CLAIM OF PRIORITY

The present application claims the benefit of U.S. Patent Application 60/938,386, filed on May 16, 2007 and of U.S. Patent No. 60/930,637, filed on May 17, 2007, which are hereby incorporated by reference.

### FIELD OF THE INVENTION

The present invention relates to an advertising supported television or web broadcast which is interactive, customizable and assembled by a user based upon individual preferences.

### BACKGROUND OF THE INVENTION

Television and web broadcasts of news, weather and sports have traditionally been provided to viewers by network and local network affiliates who assemble a program from materials that the network or affiliate producers deem to be of interest to the broadest segment of their anticipated viewing audience. Typically these broadcast programs are provided to the viewer free of charge, save applicable access charges for cable, satellite or internet access. The broadcasts are typically paid for by advertisers who sponsor the programs. The advertisers will have their commercials broadcast to the viewers at appropriate intervals within the broadcast. The viewers' choices have traditionally been limited to selecting which of the various network or affiliates' broadcasts to watch. Traditional (news) broadcasts are typically designed to be 30 to 60 minutes in length with approximately 25% of the (time) devoted to commercial (messages). Further, the time and mix of the content relating to the news, weather and sports is regimented by the producers of the broadcast. (The consumer of news and information is a passive observer in the process).

With the advent of the internet and news, weather and sports services providing web broadcasts, the users have had a greater number of choices. A user on a browser accessed broadcast or news service, may select individually offered news, weather or sports stories whether or not they are associated with a video clip supporting the item for immediate review. Each (story) is typically selected by activating a link which immediately opens a new page or window within the browser, one that contains detailed information relating to the item selected by the user. Many web-based news services are typically supported by paid advertising in essentially the same manner as traditional television-based broadcasts. Advertisers will pay the web broadcaster for space or links on the web page to publish their commercials. Some of the web-based ads are passive links while others are streaming audio and/or video commercials that run automatically as the web page is accessed by the user. Other web based ads include floating or crawling graphics that will overlay the user's PC screen and require affirmative action by the user before the selected content will be presented to the user. More often than not these “pop-up” or crawling ads are annoying to the user. Advertisers and web broadcasters are looking for new and (effective) ways to present commercial (messages) to the user who is utilizing their service. Users are routinely looking to software solutions (such as “pop-up” blockers) to prevent these ads from automatically appearing and cluttering the screen. With respect to video broadcasts of news, weather or sports stories offered on the web, the user cannot observe the selection without first viewing a commercial selected and provided by the broadcaster. Regardless of the type of commercial device employed by advertisers and broadcasters, the user has virtually no input or choice with respect to the matter except to possibly activate the advertising link for even further information on the product or service presented to the user.

### SUMMARY OF THE INVENTION

This invention relates to a method of providing broadcast information, such as those of a network, regional or local network broadcast affiliate. The invention provides for a system of advertiser-supported information dissemination, whereby a user is provided with a menu of offered programming segments and potential advertising segments. From this menu the user selects the individual story items of interest to the user along with only those ads or categories of ads that have been offered into a customized broadcast that has been tailored specifically by and for the individual user. The broadcast can be customized not only as to content of the subject matter of the news items and commercials viewed, but also as to the length of the total broadcast and the specific mix of national to local news as well as the order of the stories viewed. As such the user-viewer creates a customizable information template that relates to not only news content, but opt-in advertising messages.

The invention creates an interactive broadcast which gives the user additional opportunities to provide the broadcasters with feedback, or for the broadcasters to offer the user additional materials based upon the user's selections or pre-stated preferences. Additionally, users may provide content to the broadcasting company which could be reviewed for quality and content by the broadcaster and then made available for potential viewing to other user-viewers, who can now select this user-generated news clip for their own customized broadcasts. The system is also interactive for rating the quality and content of user-submitted materials as well as the content provided directly by the network or network affiliate.

The invention is platform-independent and can be offered through cable or satellite television-accessed services as well as internet based services. It is operating system and browser-independent.

### BRIEF DESCRIPTION OF THE DRAWINGS

FIG. 1 is a rendering of a web-based embodiment of the invention showing a page for assembly of the customized broadcast.

FIG. 2 is a rendering of a web based embodiment of the invention which shows the assembly of ads and features selected into a unitary customized broadcast.

FIG. 3 is a system overview.

FIG. 4 is a clip database schematic.

FIGS. 5-14 show page layouts that define the admin tool functionality required to add, edit and manage clip and user content.

FIG. 15 shows a workflow diagram for the administration of user generated content

FIG. 16 shows a data diagram that details the tables required for managing permissions within the admin user interface.

### DETAILED DESCRIPTION OF THE INVENTION

The present invention concerns a useful, novel and non-obvious alternative to the relatively unchanged business model of broadcast television that has existed since the first over the air television program was demonstrated on Jan. 13, 1928. While the hardware and the software used to deliver programs and information has advanced significantly during that time frame, the program format and the economic system employed to pay for the programming has not.

For example, a typical local news program today follows this format: several news, weather and sports “anchor” persons (almost universally in that order) present a series of stories and features selected by producers, interspersed with commercial messages that account for approximately 25% of the total program broadcast time. With variation only where a breaking news story or developing great storm or overriding sports story intervenes, the typical news cast devotes the same amount of relative time each broadcast for news, sports and weather without any ability to vary that content mix for viewers from household to household or neighborhood to neighborhood. Despite the fact that within a typical local network television affiliates broadcast reach, there could be a great variation in the amount of interest in a particular story from community to community. Indeed, even within an individual household there can be a great deal of variation in the interests of the user in the various news, weather and sports stories being offered that afternoon or evening. Heretofore, the producers of the news programs would choose what they felt was the most timely and newsworthy to the largest group of viewers, or perhaps those stories which were the most universally marketable to their captive viewers. Viewers' choices historically have been limited to which set of news, weather and sports anchors to watch or, more recently, whether to watch at all. Recent viewer trends, for a myriad of reasons being discussed in a variety of forums, are turning off traditional television newscasts. Viewing trends show a continual annual reduction in total number of people watching television news. Broadcasters have been earnestly looking for a solution to reverse this trend and generate more interest in their news content. Even a relatively small television station in the smallest of markets represents a multi-million dollar investment and is at risk to this continuing trend.

One of the factors that have contributed to this trend of disappearing television viewers is the rise and ubiquity of the internet.

Since the widespread accessibility to the internet by the public beginning in the 1990's there has been a continuous and dramatic growth of news and information available to the public via on-line sources. Further, with the dramatic improvement in hardware and software as well as the growing access to broadband, the quality of the material available over the internet has dramatically improved.

Quality streaming on demand video is widely available and has been extensively employed by web-based broadcasters. Consequently web based new services, such as those offered by CNN.com, MSNBC.com, FOXNEWS.com and the like, provide an alternative source for news to traditional broadcast television—not just for print stories, but also for video-supported news stories. The web-based broadcasters also offer the user the flexibility to select the specific stories to watch or read as well as the flexibility to select their own time to get their news. With the web based news services, the user can also choose how much time to devote to getting their news, weather or sports. The user can also decide whether to follow a particular story in greater depth by conducting a web-based search on the subject using any number of search engines and protocols available to the user on the internet. Indeed, a user looking for news on the internet can also find postings from individuals with video clips of events that have been uploaded to web services like YouTube® or Google® News. These pieces can be found by searching in a variety of different ways with a variety of different search requests to determine if there is user-generated information that is available on a particular topic or story. The web-based services delivering professionally generated news, such as CNN®, or user generated content, like Google® News, have typically been supported by advertising rather than paid subscriptions or enrollments. Indeed, one very interesting aspect of the web-based news services is that they have followed a very traditional business model for generating revenue—paid advertising. That web advertising appears prominently on the web page variously as a pop-up, streaming video or talking “billboard” that requires that the user watch it or take some affirmative action to deal with it. In fact a whole software industry segment has evolved that deals exclusively with preventing or minimizing the annoyance of unwanted pop-ups or other ad forms. In fact, the annoyance of advertising pop-ups is so great that many advertisers on the web are looking for alternative vehicles to deliver their messages. While the web-based news services offer some very significant advantages over conventional television news services, the web remains today mostly as a supplemental news source for most people. Simply turning on the television at the same time every night remains the easiest way to get the news, weather and sports for most people. You don't get the choices offered by the internet, someone else does all the work of searching through the available news worldwide and assembling it into a broadcast narrative that you can just sit back and watch as a passive observer. Traditional television news viewers are also ensured that the information they will be seeing meets known standards for reliability, quality, and propriety that they have come to know and expect of their long trusted and favorite newscaster or network. To maintain its public television broadcasting rights a local television station must comply with those standards or risk FCC censure and fines. No such protections or standards of quality, reliability or propriety of content are provided when a user selects a news item posted by a user on an internet weblog. Traditional over the air television will still push the ads they want you to see, regardless of whether you are interested or not, but they won't install unwanted “spyware” in your television set.

A need exists for a new method of providing advertising-supported content to users which is interactive and fully user-customizable as to both the programming and the advertising. Taken together this creates a completely integrated broadcast produced by the user based upon materials managed and offered by the broadcasting service. A need exists to utilize a best practices and leverage the integration of internet and the broadcast world, tapping the advantages of traditional television programming combined with the personalization and customization offered by web-based services, in a way that neither approach has heretofore employed on its own.

The present invention is an alternative to traditional television broadcasts and is also materially different from current web-based news and information services. It provides for user-customization of both substantive content and advertising based upon the user's individual selections and pre-designated preferences. The broadcast service provides content selection choices to the user in a variety of categories. The categories can be further subcategorized to assist in the review by the user. News, for example, could be categorized into specific subcategories depending upon the degree of granularity desired by the user. Categories could include, international, national, regional, metro, community and neighborhood. From these categories the user could select as many of those offered features or stories as then interested the user or that the user had time for at that sitting. The user could emphasize international over local news or visa versa. In essence the scope and content of the customized broadcast would be “produced” by the user and not the network or affiliate producers. The user becomes the defacto news director for an audience of one. The task of the network or affiliate producers leveraging the present invention would be to accumulate and create a wide variety of content choices to make available to a user for inclusion into a customized broadcast that would vary as to content and length such that no two assembled broadcasts would necessarily be alike. The news could be further categorized into topical categories to assist the user. Topical categories could include current “headline” events, politics, law, technology, health, education, entertainment, business, etc. Like the news, weather and sports could be similarly subcategorized. For example, sports could be arranged to include choices for baseball, basketball, football at international, national, collegiate, high school levels. Beyond the kinds of stories that would be typically offered on a local television affiliate's local evening newscast, the present invention could provide for the ability to select stories that would emanate from a user chosen favorite college sport from across the country, a story that would otherwise not typically receive any coverage in that market. The broadcaster could also include content that was submitted from user contributors in the daily offering of viewing choices for its audience, along with stories produced by local reporters. With the ubiquitous availability of cell phones with video cameras people are capable of capturing breaking stories and transmitting them to a network or local TV affiliate for re-broadcast or inclusion in a more expanded story utilizing the user-submitted content in whole or in part. New personal communication tools with high-speed wireless connections have made virtually everyone with these tools capable of assisting in the assimilation and reporting of news stories as they are unfolding from virtually anywhere, anytime. The interactivity of the present invention also includes the ability of the user to rate the quality and value of both user and network offered materials to help other users gauge the relevance, importance and interest of a specific video clip for possible inclusion in their customized newscast.

While the system of the present invention can be utilized in a variety of platforms, whether it is software loaded onto a set top box provided by a traditional cable company provider, or a TIVO® type video hard drive, or a smart phone mobile device, the invention can be adapted to work on those platforms by using readily available software applications.

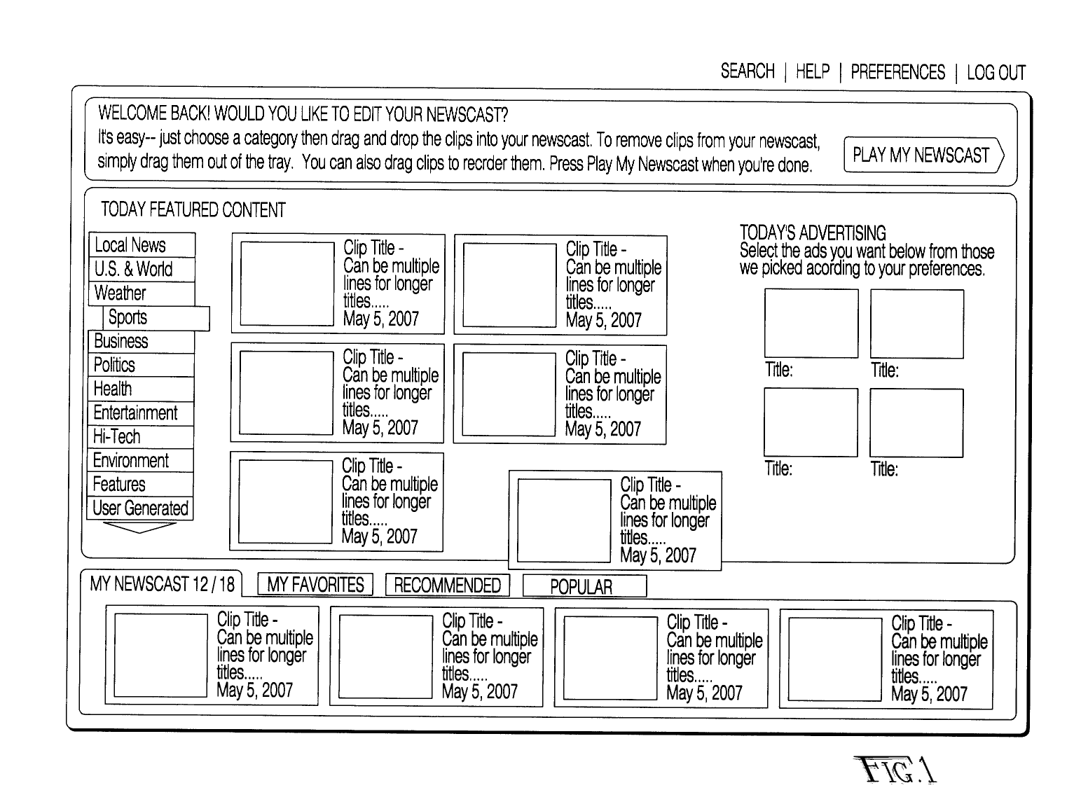

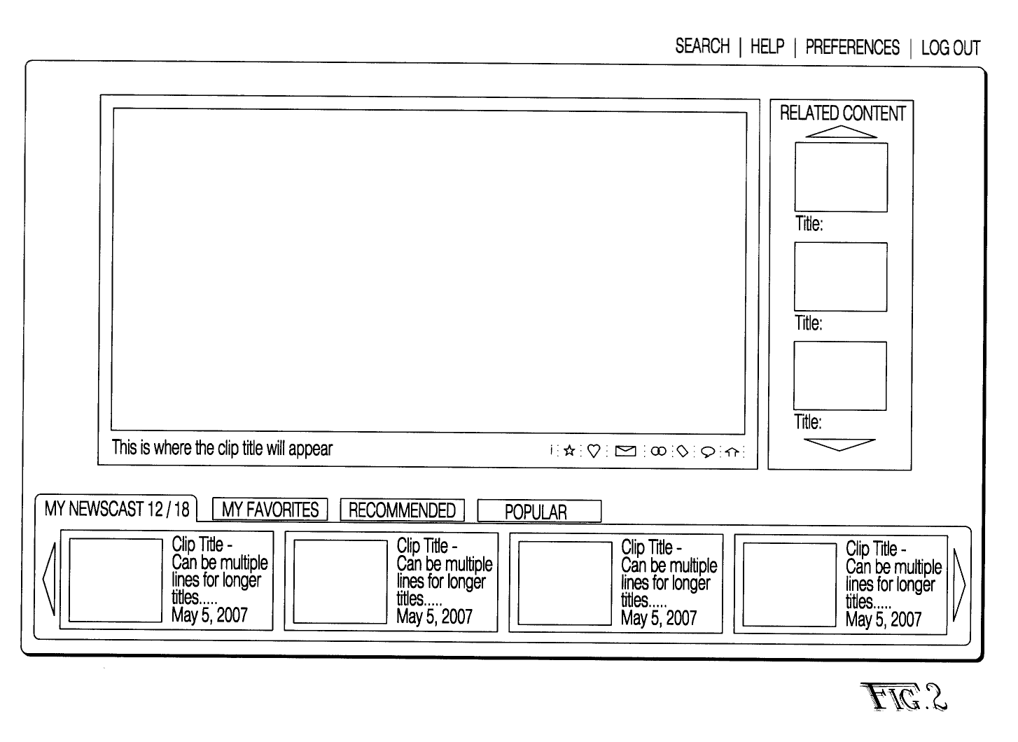

The following description and diagram shows an embodiment of the present invention which includes a software player for the assembly and playback of the individually-offered broadcast news items and ad spots. The embodiment as shown in FIG. 1 above shows the web page from the service of the present invention where the customized newscast is assembled by the user. The user is presented with the featured content video clips offered at that time by the broadcaster or content provider, content supplied from multiple sources, including network, local and user-generated. The featured content is organized topically by tabs at the left of the side of the viewer. The user selects a category, for example “sports”, and the offered content is displayed in the form of multiple video clips. The video clip icons indicate the title of the clip, the length of the clip, the date the clip was created, a rating of the clip generated by other users, and other relevant and helpful information to the user. A clip is selected by the user and by using a “drag and drop” feature it is moved from the “featured content” section into the user “my newscast” video clip strip at the bottom of the screen. The selected clips are dropped into an “open” icon on the “my newscast” strip serially in the order the user wishes to see them. The user can change the order of the selected clips or can even remove a selected clip before they are assembled into the customized broadcast.

On the right side of the assembly screen is the advertising clip choices offered to the user. The advertising clips are offered by the content provider in much the same manner as the featured content clips. The advertising clips can be organized with tabbed categories (not shown) in a similar fashion to the featured content. For example, the advertising clips could be organized under categories like Food, Fashion, Travel, Automotive, Electronics and so on, to assist the user in choosing which offerings are of interest to the user. It also permits the user to skip advertising which has no interest or relevance to them.

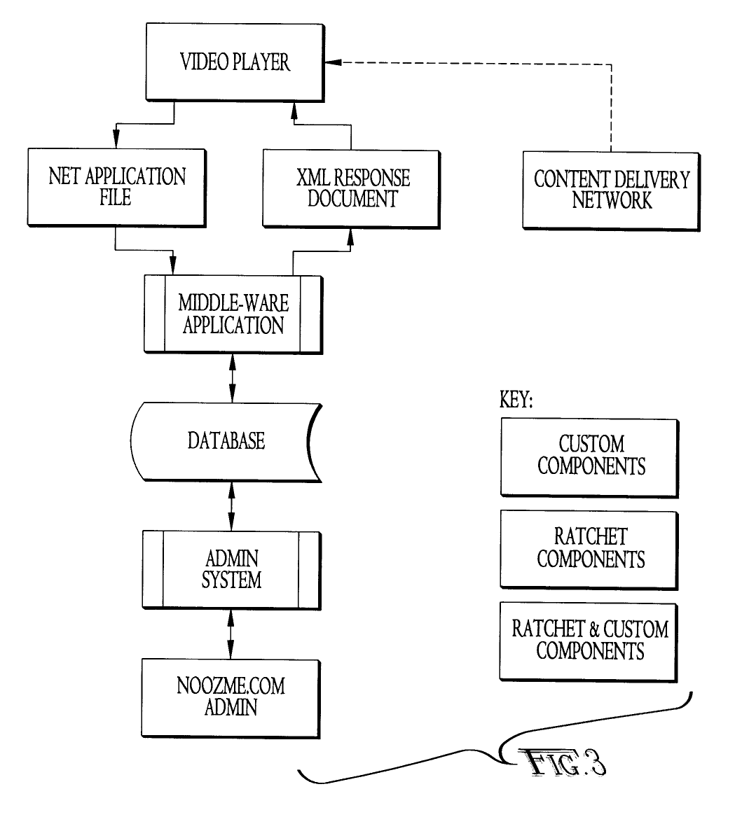

The present invention also provides for pre-selected user preferences. The preferences can provide a wide variety of input with respect to the specific likes and dislikes of each individual user relating to a wide array of subject matter. The user can also employ the preferences feature to advise the content provider about categories of advertising that the user is or is not interested in. Similarly, through a series of questions or interactive maps, a user can state geographic preferences for news stories or other featured content. The link, “Preferences”, shown at the top of FIG. 1, provides the user with access to choices that can be made regarding categories of featured content, advertising, geographical and other topical choices. This feature of the present invention permits the user to be able to more quickly assemble and produce a custom broadcast that is uniquely tailored to the user's interests. It permits the content provider to also pre-assemble a “Recommended” broadcast based upon the stored individual preferences specified by the user. The “Recommended” tab is shown on FIG. 1 and FIG. 2. FIGS. 1 and 2 also include a “Popular” tab. This feature permits the content provider to present to a user a recommended broadcast that represents, for example, the most frequently selected stories and advertising spots of the day by other users. This “Popular” suggested broadcast appears at the tab on the bottom of the viewer associated with the assembly clip strip. This feature permits the user to then quickly customize the “Popular” broadcast by eliminating certain features or ads in that offering as well as quickly substituting a featured clip or two selected by the user. The “Recommended” broadcast can be similarly tweaked as to content or advertising at the choice of the user before playback.

While the content provider is working continuously to supplement and update the vast amount of information available to offer the user, the preferences act as a filter to further refine and limit the offerings that are presented in the “Today's Featured Content” section of the present invention as depicted on FIG. 1. Another aspect of the present invention is the learning feature of the user's stated preferences. That is, the present invention employs the web technology that “learns” from the choices made by the user on an ongoing basis and then is able to predict other items that may be of interest to the user. This web technology is similar to that employed by web merchants like Amazon® in learning the purchasing preferences of their customers. Each time a choice is made, the system further learns and refines the user's preferences to permit the content provider to more completely serve the user content and advertising that the user prefers.

The preferences can also include the ability to select all stories or features created by favorite news anchors or reporters or all editorials of a favorite commentator. Similarly, the user can choose to accept all new advertising and press releases from favorite companies that relate to certain products or services. In addition, the learn feature permits the system to learn and predict what stories, features and advertising the user may also wish to choose from and offer these predictive options in the “Related Content” section as shown on FIG. 2.

The “Related Content” feature can also be an interactive “crawl” that is scrolling constantly to the side of the main viewer player during playback of the customized broadcast. The “Related Content” may include both featured content and advertising as well as links to websites of potential interest to the user. This feature, as shown on FIG. 2, would permit the user to pause the broadcast during playback to pursue a related piece in more detail. This “pause and pursue” feature would also permit a user to interrupt the custom broadcast and get immediate information on a brand new product offering that just appeared on the active crawl section adjacent the user.

The number of advertising clips required by the content provider can vary as a matter of choice by the content provider. For example, advertising could be required in a ratio of selected featured clips to advertising clips that would approximate the ratio of substantive programming to advertising used in current commercial programming. Alternatively, the content provider could require 1 ad clip to be selected for every 3 featured items chosen. Any number of alternatives may exist for determining the kind and amount of advertising required to be selected for the featured content selected by the user.

Once the featured clips and advertising are chosen the user can press “Play My Newscast” and the player will assemble the newscast into a cohesive, streamed broadcast that the user can simply sit back and watch. FIG. 2 shows the customized broadcast being assembled in the viewer along with the controls for playing the broadcast. FIG. 2 also shows another feature of the present invention. It shows a featured “Related Content” section which is additional material that may be provided by the content provider that is deemed to be related to the featured content previously selected by the user on FIG. 1. This feature enables the user to pause the assembled customized broadcast to click-thru a related news feature or advertising message that may be of additional interest to the user. Upon completion of viewing the related content the user can resume watching the paused customized broadcast. The related content feature can also include standard web links to other content including, for example, the featured advertiser's home pages.

Unlike current web-based news services the user does not have to individually select and then play the entire clip (along with the obligatory pre-roll or post-roll advertising message typically accompanying each clip). Before a user sees the next item of interest to them they must find, and separately select that clip for immediate viewing in its entirety along with its obligatory advertising.

In addition to the customization and personalization of news and advertising content, both audio and video, the invention permits the user-viewer to create and view a customized news “crawl” or “scroll” on the screen. This too can be tailored for a user-viewer's preferences and tastes, with the additional advantage of filtering out news, sports or weather-related stories for a specific town or suburb, using standard search and filtering technology. Instead of everyone seeing the same news crawl, a user-viewer watching their newscast on the internet would have the advantage of receiving personalized crawling text messages, tailored for geography (hometown or multiple locations of interest) and preferences.

In current web-based services and traditional television broadcasting there is no known system that permits a user to select only the featured content of interest to them and to individually select the advertising messages of interest to them, and then “produce” an integrated and interactive customized broadcast for immediate or later playback. Further, the present invention is the only known service which will permit the assembly of a suggested or recommended broadcast by a content provider based upon detailed preferences pre-specified by the user.

The following diagrams, figures and description, show one way that a web based embodiment of the present invention may be constructed. It can be implemented by a person of ordinary skill in the art by combining standard web based applications and other common software tools and techniques.

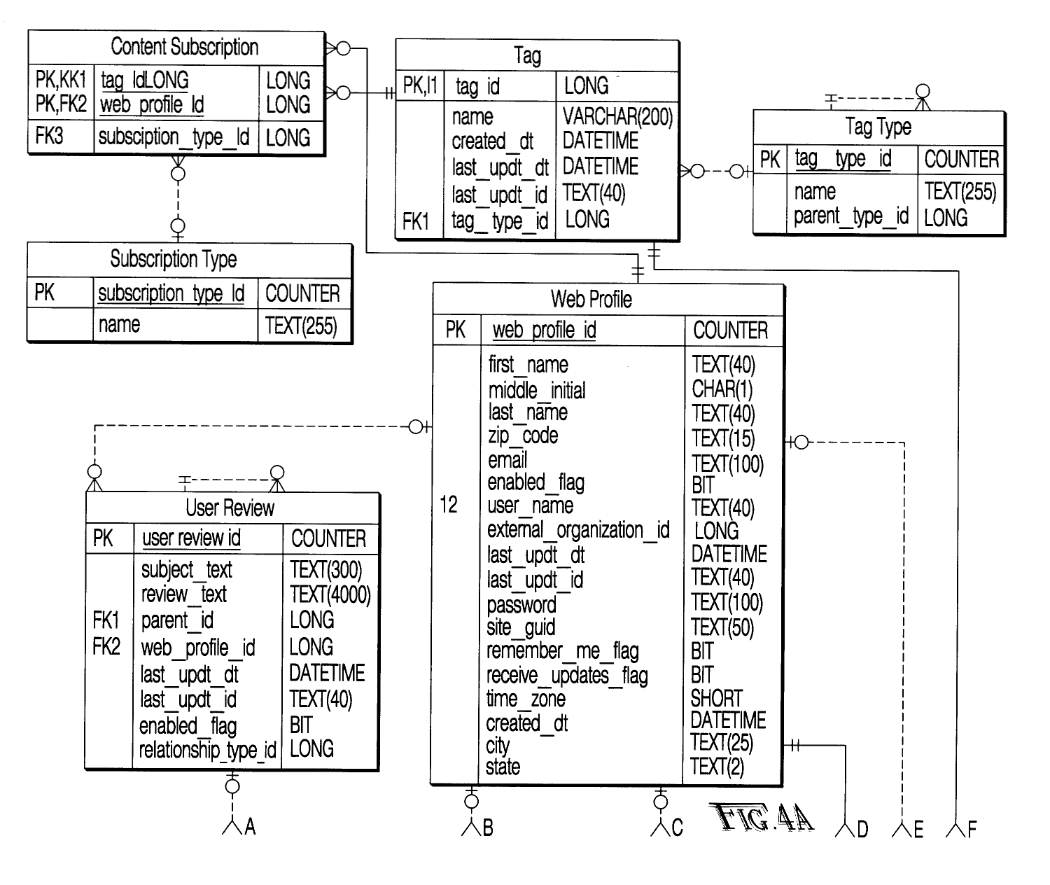

The embodiment of the web interface depicted in FIGS. 1 and 2 above may be implemented as follows. A system overview is shown in FIG. 3. There are four components that make up the system: a custom flash video player interface, the business-logic tier that serves data to the player based on pre-defined business logic and application specific settings, the ad serving and management system, and the administrative system that allows site managers to add, edit and delete content, settings and preferences.

### Player Interface

The custom flash video player interface primarily serves as a video display mechanism. The system delivers content to the player via XML documents generated by custom-built middleware application when the player makes a request following a user action. The middleware will return XML populated with all of the requisite copy and video URLs, in addition to any URLs required to link to additional information. The player then parses the XML content and uses its data to display video and related content within a single interface. The player is constructed in Macromedia Flash for Flash Player 8.0. The mechanisms which retrieve and parse XML from the middleware system are semi-custom implementations built by Ratchet, while the interface is entirely custom to the application.

### Middleware

The middleware application was built using Microsoft .Net 2.0 written in C# and utilizes a SQL 2005 database as its back-end data store. It uses pre-existing content management libraries, (which may be custom generated or available from developers like Ratchet, Inc. of Minneapolis, Minn.) which include page and entity content relationships, Ratchet Flexible Messaging, (also available from Ratchet, Inc. of Minneapolis, Minn.) account/profile management, search, and page, entity and object level caching. In addition, the system utilizes adaptive recommendation logic to serve related content to the user in the context of the current video or content they are viewing.

The application is session-less and can be served from a load balanced infrastructure, both within a single physical environment or geographically distributed between several physical environments.

The player relies on the middle tier to deliver content in XML format which it parses and displays to the end-user. The middleware provides the following data feed interfaces:

| Data Feed Name | Arguments | Return Data |
|---|---|---|
| getNewsCast | userid | All clip detail that relates to |
| | type (optional): | user's preferences if no type is |
| | Popular, | given or per the type provided |
| | Favorites, | |
| | Recommended | |
| getCategories | | All categories and subcategories |
| getCategoryClips | categoryid | All featured clips in category |
| | | provided |
| getAds | userid | All ads pre category per user |
| | | preference |
| getRelatedContent | clipid | All related content per clipid |
| | | provided |
| getUserProfile | userid | Preference data per userid |
| | | provided |
| getSearchResults | Search terms | All clips that match search terms |

All feed interfaces that return clip information will return the data in the following XML format:

```
<clips>
          <clip id=”123” date=”05122007” length=”2:05”
          source=”WCCO” avg_rating=”4”>
          <desc=”Lorem ipsum dolor sit amet.” />
          <categories>
                <category id=”1” name=”Weather”>
                <category id=”23” name=”Local Weather”>
          </categories>
          <tags>
                <tag id=”23” name=”tornado season”>
                <tag id=”23” name=”paul douglas”>
          </tags>
          <related_clips>
                <related_clip id=”1” name=”Clip Title”>
                <related_clip id=”1” name=”Clip Title”>
          </related_clips>
</clips>
```

The player also relies on the middle-tier application to write data to the database regarding user preferences, newscast selections and ad selections. The middleware provides the following interfaces to the player that facilitates this data store:

| Interface | Arguments | Return Data |
|---|---|---|
| setNewsCast | clipid | Confirmation or error code with |
| | userid | message |
| setPreferences | accountid | Confirmation or error code with |
| | account information | message |
| | newscast settings | |
| | advertising settings | |

### Database Scheme

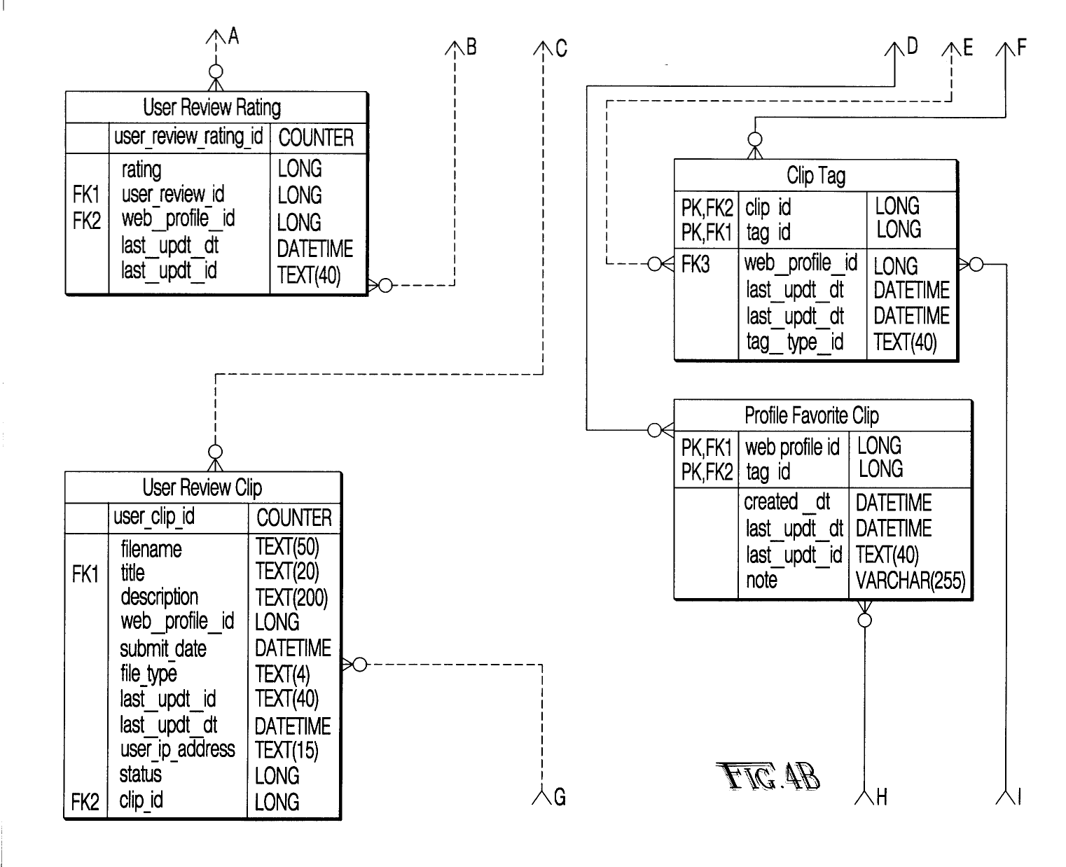

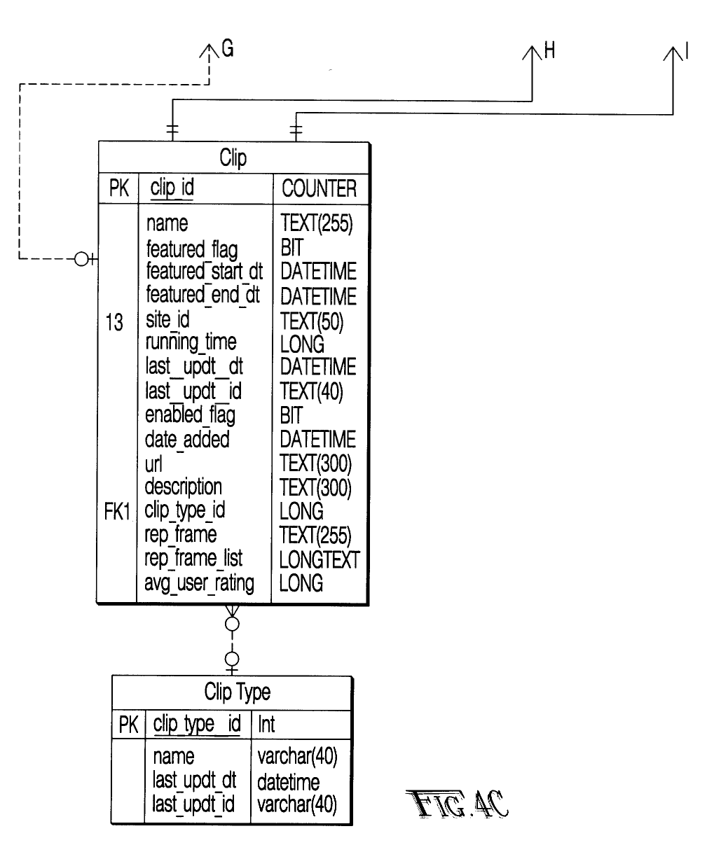

The database shown in FIG. 4 depicts the database tables required to store the data for organizing, displaying and relating clips.

### Ad Server and Management

The system will integrate with the DART ad serving platform from DoubleClick systems. The DART platform will be used to serve all ad content that is distributed via the player. The player system will make a call to the server after n number of clips viewed (defined in the site's web config file) in the form of a DART tag, as follows:

http://ad.doubleclick.nethafadx/slgc.hm/main;slgc=ad;pos=primary-ad;tile=10;sz=480×270;

The DART system returns a path to the FLV or SWF file as determined by the ad type designated at the time the ad was trafficked.

### Admin System

The site administration system allows content editors to add, edit or remove content, including videos, images, copy or interactive content. Admin users login to the system via URL, are authenticated and granted access to the areas of content they are allowed to edit. The user can then publish the changes to the production environment or send changes to an editor via the publication workflow process. The admin system is also built using Microsoft .Net 2.0 written in C# and uses Ratchet's libraries for data access and content administration.

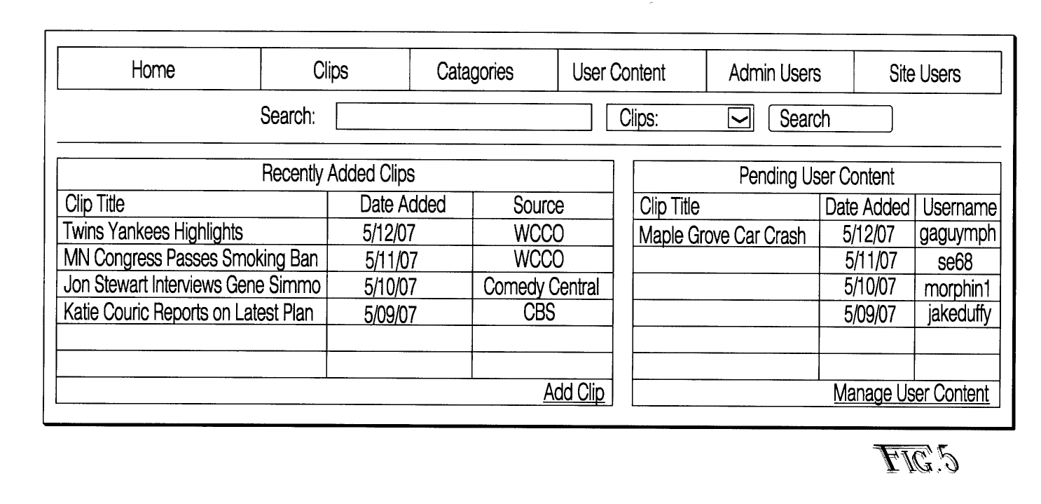

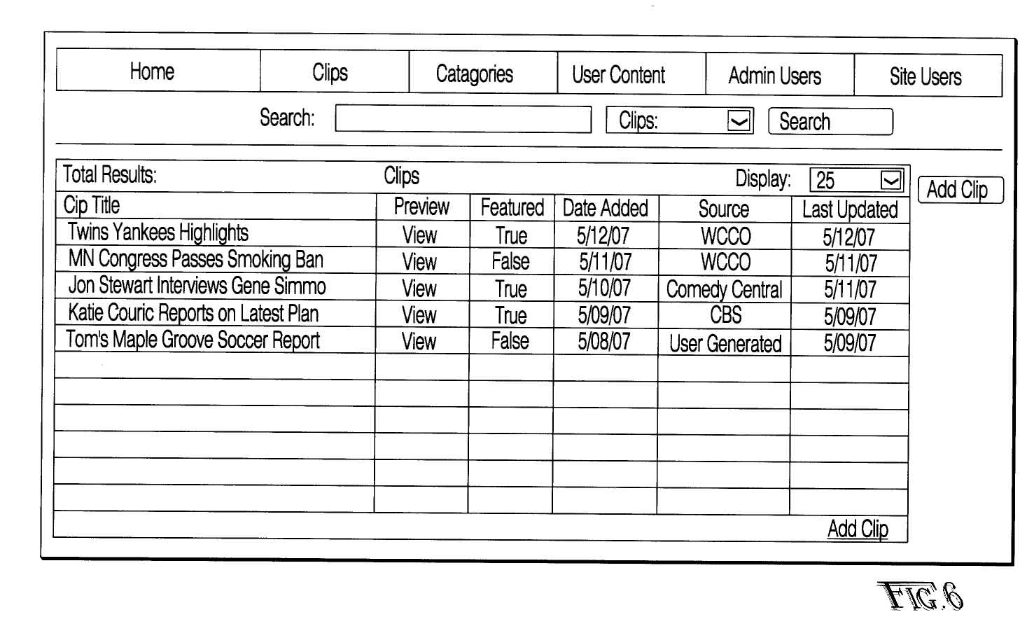

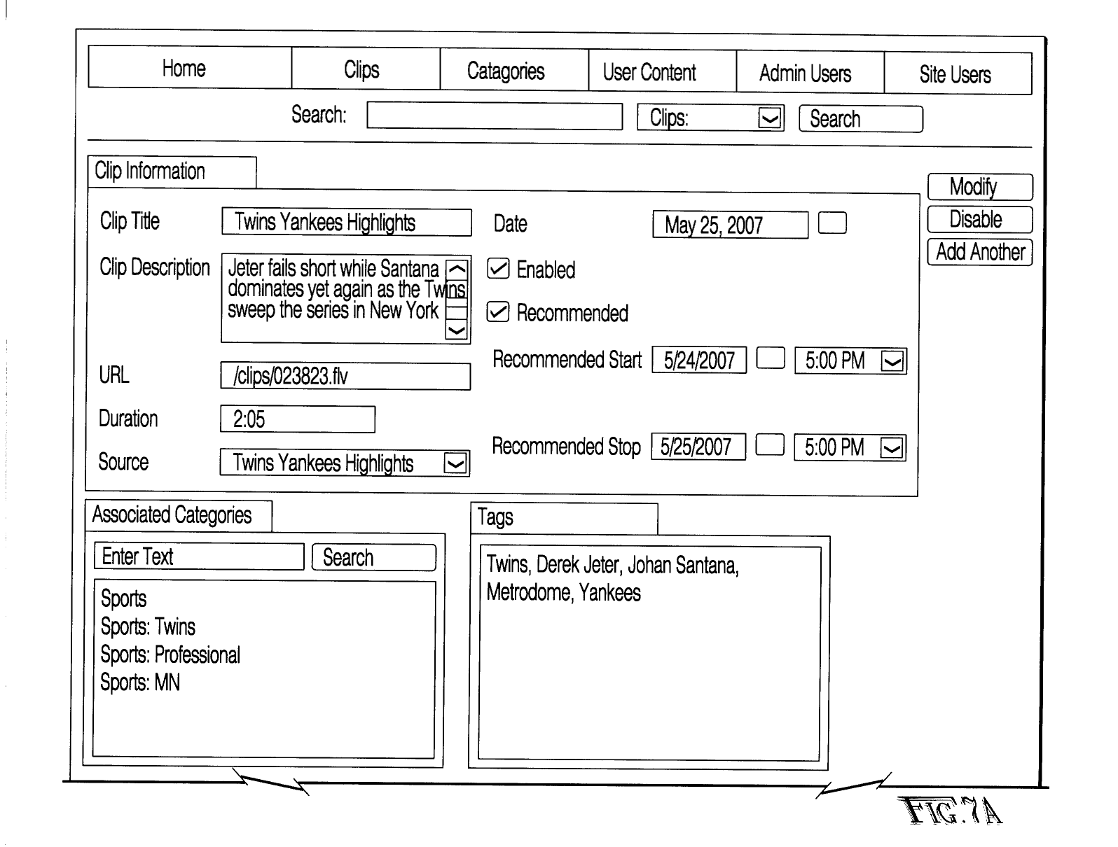

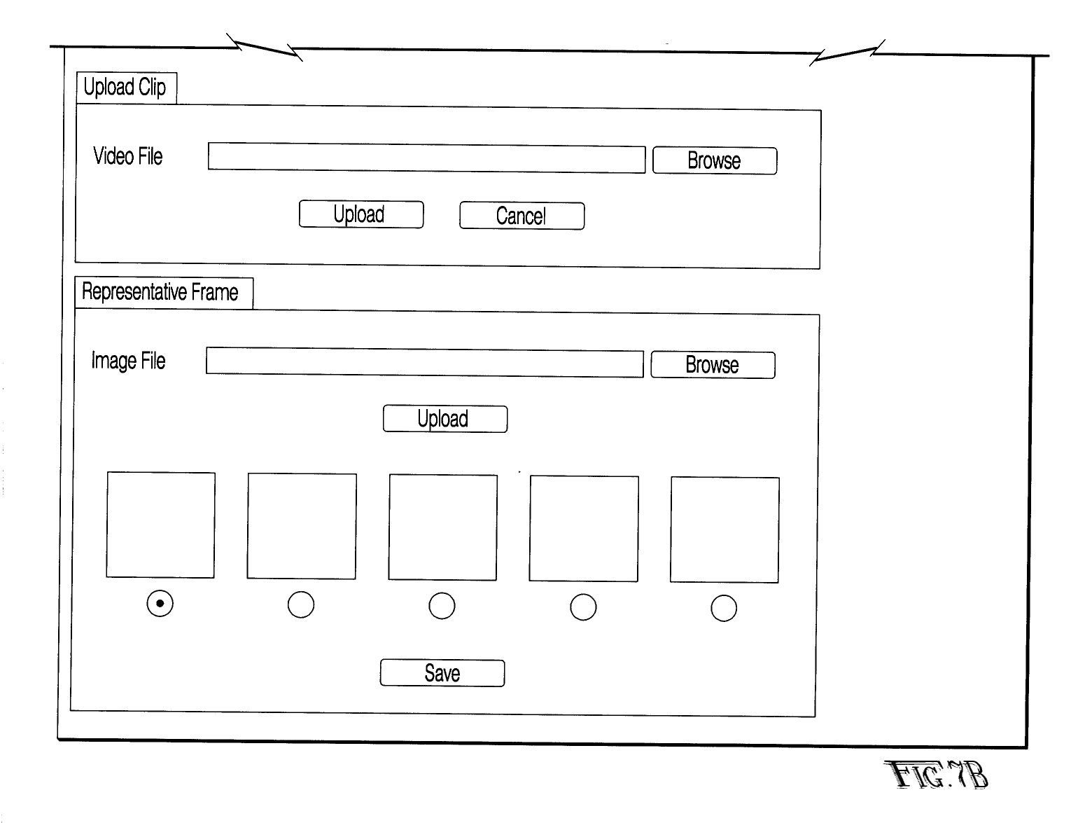

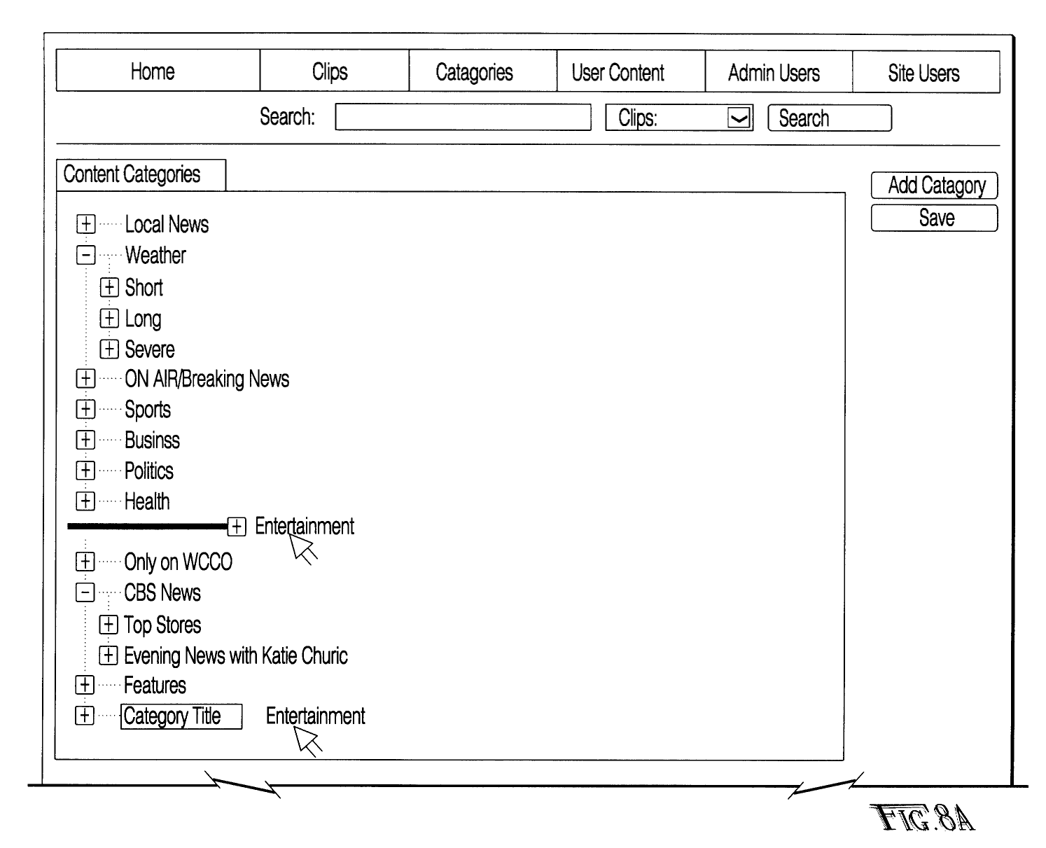

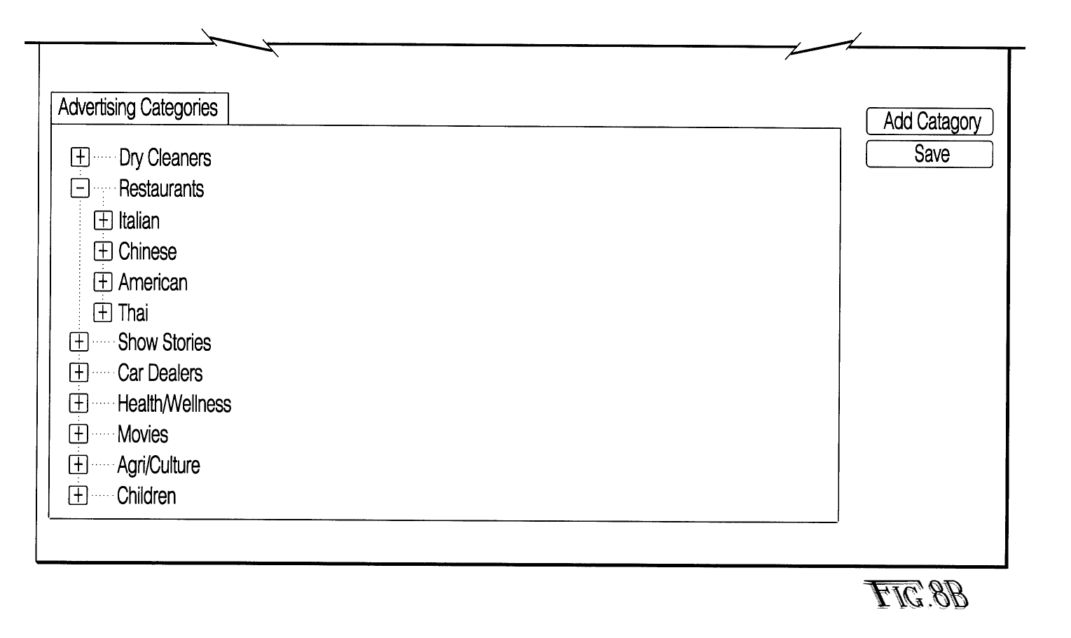

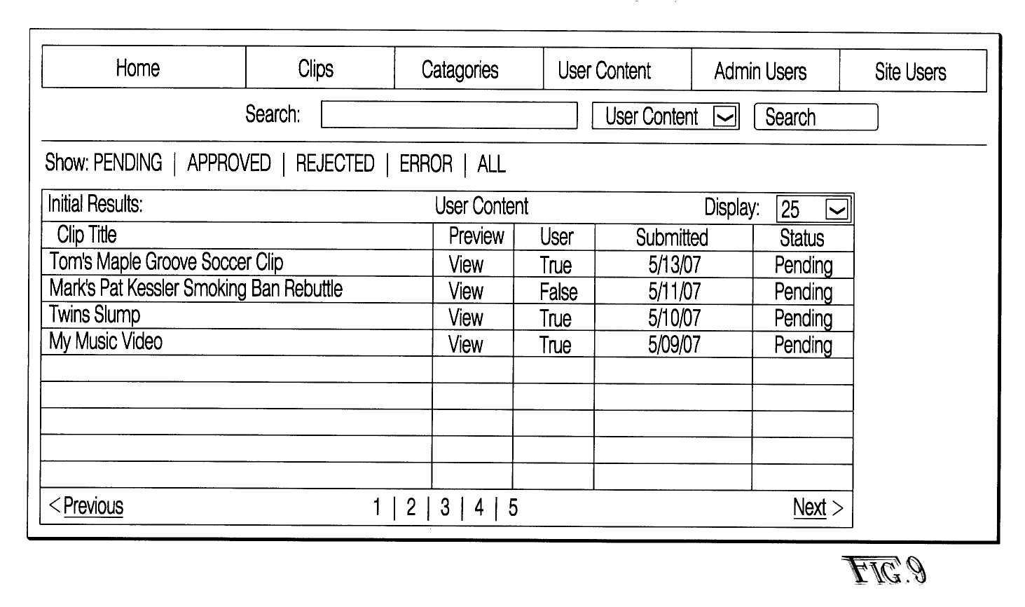

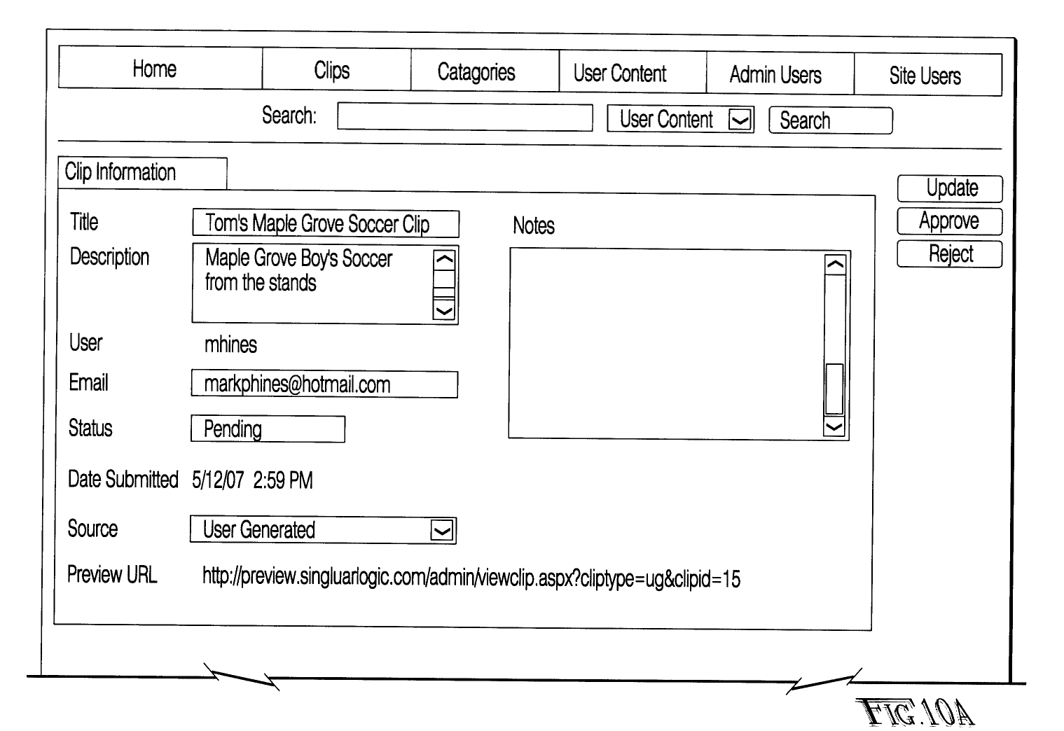

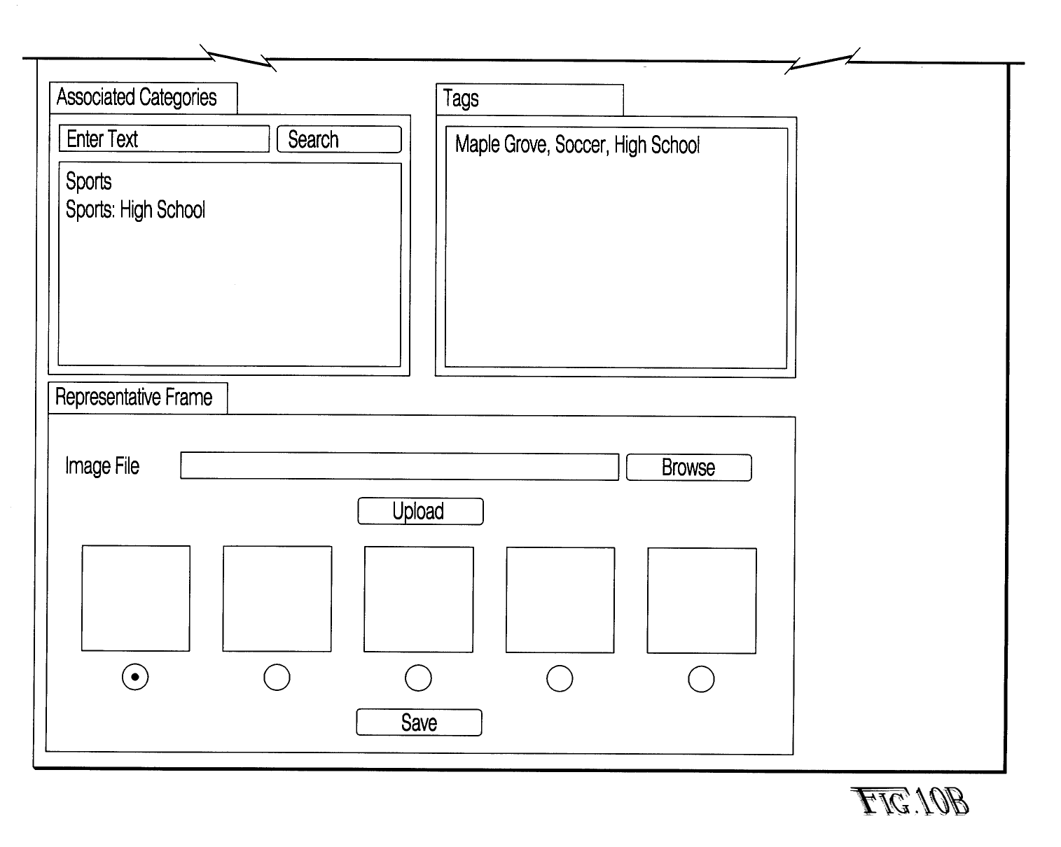

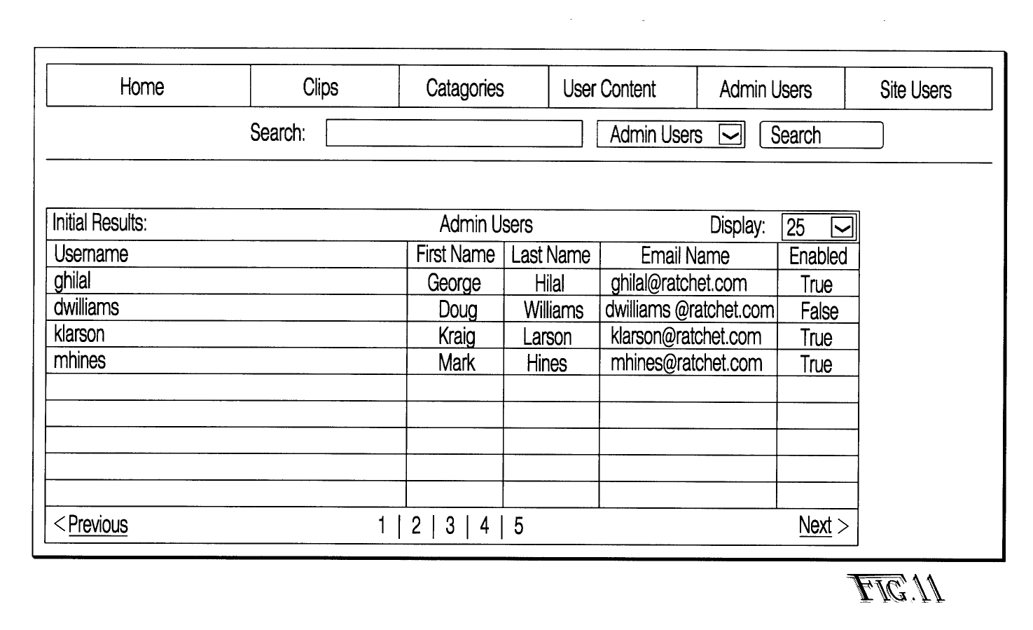

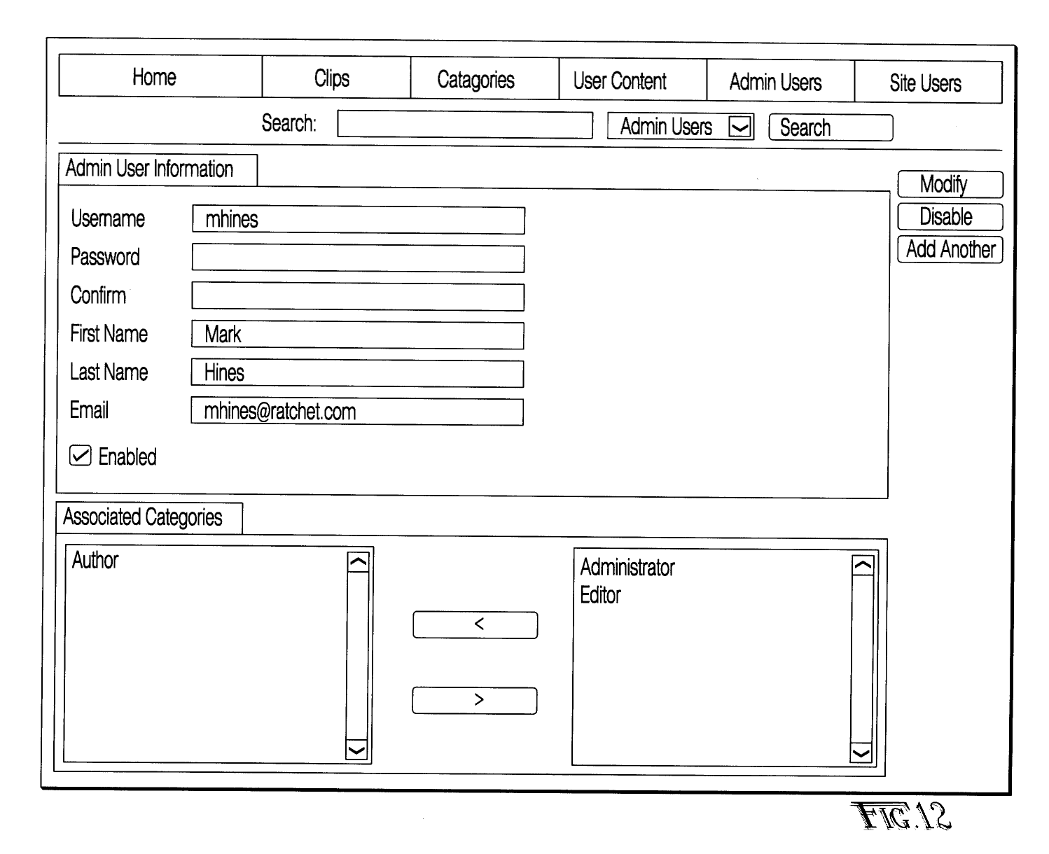

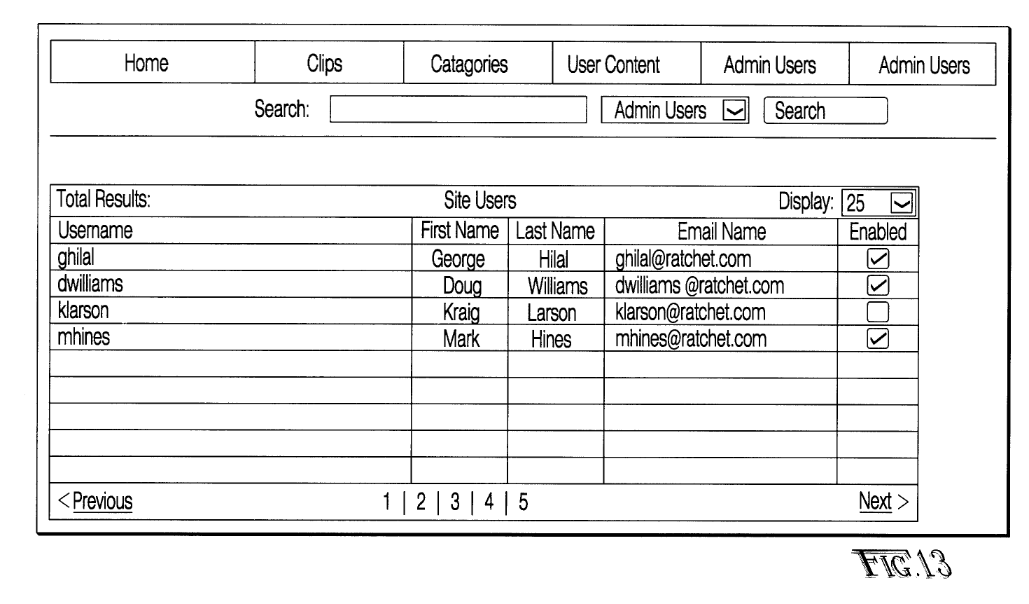

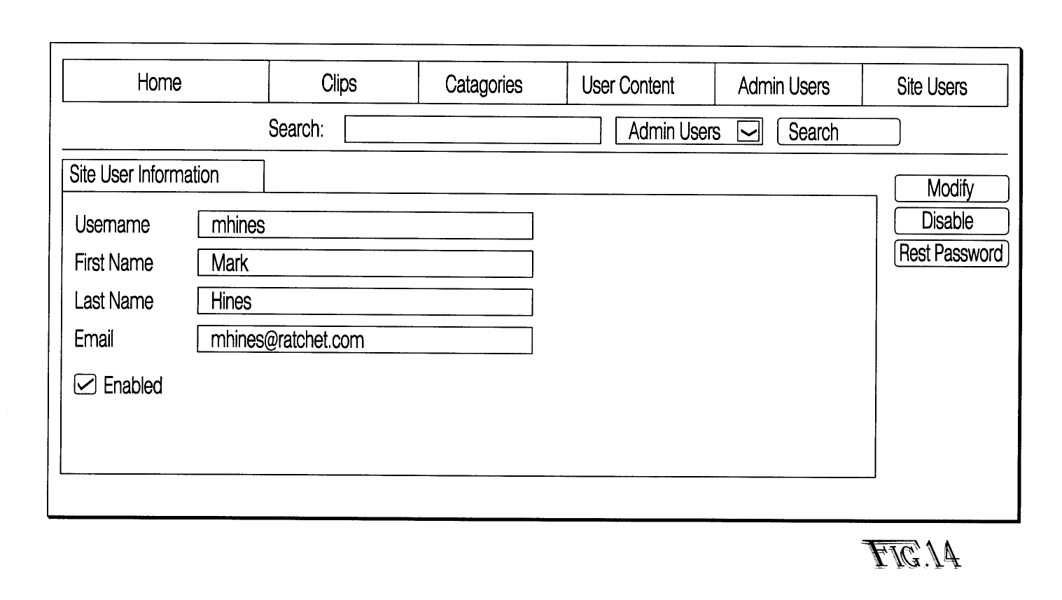

The admin system is broken into six sections, listed below with functional detail:

| Page | Functionality |
|---|---|
| Admin Homepage | Provides user with a view on the most recently added clips in the system |
| (FIG. 5) | Sortable by clip title, date added, source |
| | Default sort is by date added descending |
| | User is able to add a new clip to system from homepage which takes |
| | them to blank clip detail page |
| | Click on clip title takes user to the clip detail page for that clip |
| | Provides user with a view of the most recently add user generated content in |
| | the system that requires action (is pending) |
| | Sortable by Clip title, Date Added, Username |
| | Default sort is by date added descending |
| | Manage user content link takes admin user to User content |
| | workflow (User content main) |
| | Click on clip title takes user to the user generated detail page for the |
| | that clip entry |
| | Click on username takes user to the site user detail page for that |
| | username |
| | Provides standard search with the ability to choose which type of data entity |
| | user is searching for |
| Clip main | Provides user with a view of the most recently added clips in the system |
| (FIG. 6) | Sortable by clip title, featured flag, date added, source, last updated |
| | User can change number of clips displayed on one page |
| | Total number of clip results is displayed |
| | User is able to add a new clip to system |
| | Search entity type is clips by default |
| Clip detail | Provides user the ability to edit clip information |
| (FIG. 7) | Date added is prepopulated with today's date on new clips |
| | New clips are disabled by default |
| | If no recommended start or end date exists and the clip is selected to |
| | be a recommended clip, it will always be recommended until user |
| | deselects |
| | User can associate clip to one or more categories or edit existing |
| | associations |
| | User can edit existing tags or add new tags |
| | User can upload a video file stored on a local drive or a network |
| | drive |
| | User can upload a new representative frame or select an existing |
| | representative frame which are created automatically if a clip is |
| | uploaded through the system |
| Category main | Provides user the ability to add, edit, remove and order content categories |
| (FIG. 8) | and ad categories |
| | Drag and drop functionality exists to make a category a child of |
| | another category |
| | Drag and drop functionality exists to order categories |
| | Add category inserts new category at bottom of list |
| | Default search is on categories |
| User content main | Provides user with a view of the user generated clips in a pending state, or to |
| (FIG. 9) | filter all user generated clips in different ways |
| | User can view All, Pending, Approved, Rejected clips or clips that |
| | have created an error during FLV conversion |
| | Default sort is on username ascending |
| | Sortable on clip title, user, submitted, status |
| | Click on clip title takes admin user to user content detail for that clip |
| | entry |
| | Click on username takes admin user to site user detail of that |
| | username |
| | FLV conversion occurs according to the user generated workflow in |
| | FIG. 13 below |
| | User can change number of entries displayed on one page |
| | Total number of clip results is displayed |
| | Click on View allows user to view video in a standalone player |
| | Click on clip title takes user to user generated detail page of that clip |
| User content detail | Provides user the ability to approve or reject a user submitted clip |
| (FIG. 10) | Approved entries become entries in the clip table and are managed |
| | as a clip following approval |
| | Approved trigger an email to user indicating their entry has been |
| | approved |
| | Approved entries are no longer editable in this workflow |
| | Rejected entries generate an email to user indicating their entry has |
| | been rejected |
| | Rejected entries are no longer editable in this workflow |
| | Admin user can preview clip by clicking on preview url |
| | Admin user can add notes to entry for future reference |
| | User can associate entry to categories and/or add tags |
| | User can upload a new representative frame or select an existing |
| | representative frame which are created automatically if a clip is |
| | uploaded through the system |
| | Default search is on user content entity |
| Admin user main | Provides user ability to view all admin user accounts |
| (FIG. 11) | User can change number of entries displayed on one page |
| | Total number of clip results is displayed |
| | Default search is on admin accounts |
| | Default sort is on username ascending |
| | Sortable on username, first, last, email, enabled |
| | Click on username takes admin user to admin user detail of that |
| | username |
| Admin user detail | Provides user ability to add, edit and remove admin user accounts |
| (FIG. 12) | Administrator users can reset passwords for other users |
| | Editors and authors can only view information (excluding password) |
| | Administrators can modify account permissions |
| | Administrator accounts have full read, write and remove access |
| | Editor accounts can enable and disable content |
| | Authors can add or update content only |
| Site user main | Provides user a view of the site users |
| (FIG. 13) | Sortable on username, first, last, email, enabled |
| | Default sort is on username ascending |
| | Administrator-level users can enable/disable users from this page |
| | User can change number of entries displayed on one page |
| | Total number of clip results is displayed |
| | Click on username takes admin user to site user detail page for that |
| | username |
| Site user detail | Provides administrator-level user the ability to edit or remove a site user |
| (FIG. 14) | Administrator user can issue a reset password which assigns a |
| | randomly generated strong password and sends an email to the user |
| | confirming |
| | All data is read-only, except for enabled |
| | Disabled users are unable to login to system immediately |

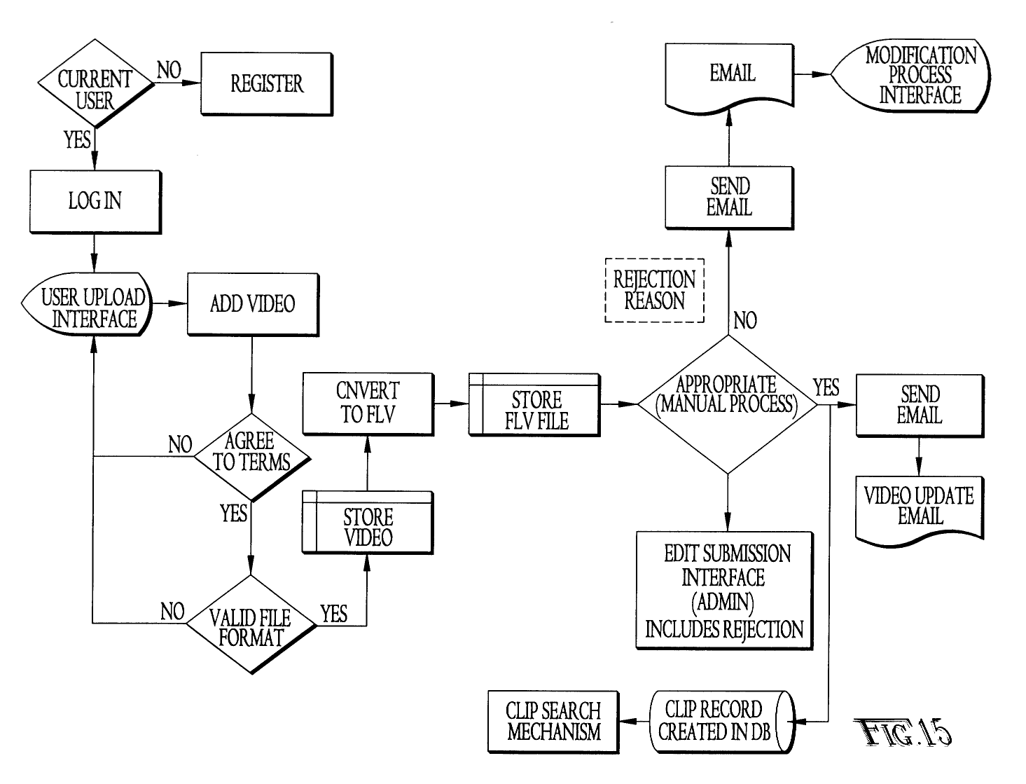

The page layouts shown in FIGS. 5-14 define the admin tool functionality required to add, edit and manage clip and user content. FIG. 15 shows a workflow diagram for the administration of user generated content.

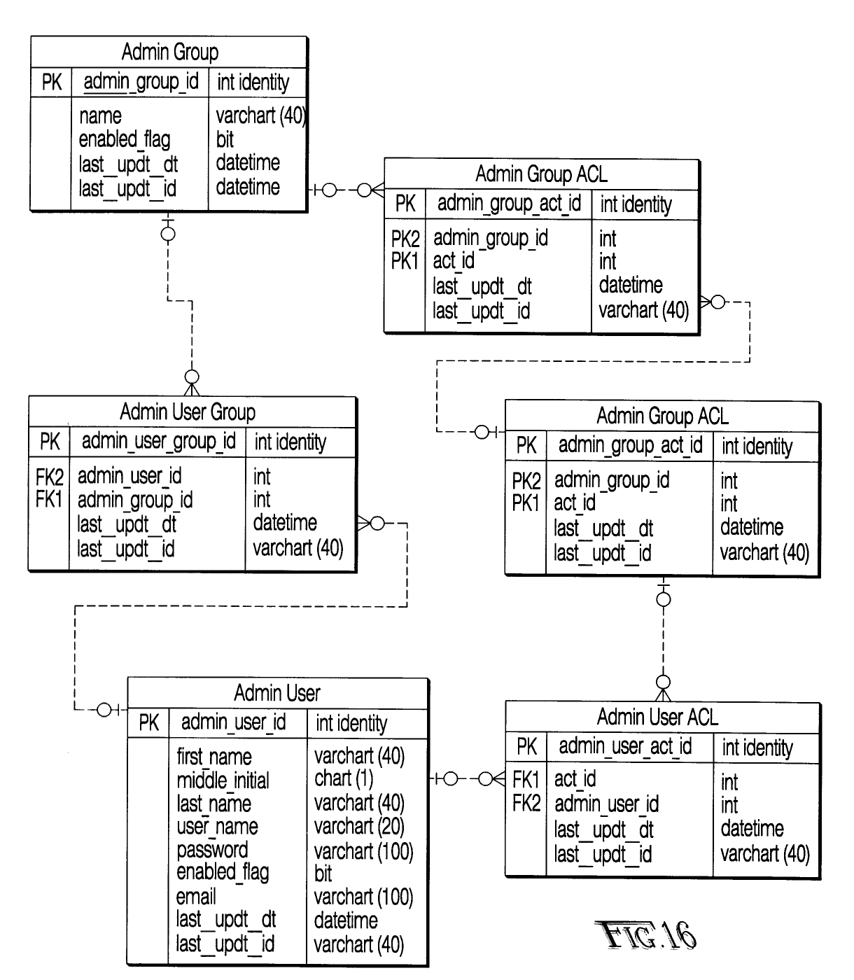

The data diagram shown in FIG. 16 details the tables required for managing permissions within the admin user interface.

### Network Infrastructure

In order to deliver the vast amounts of video data, the system requires a Content Delivery Network such as Akamai (akamai.com), BitGravity (bitgravity.com) or Limelight Networks (limelightnetworkds.com) in addition to the application server infrastructure at a top-tier managed hosting provider such as Data Return (datareturn.com) or Rack Space (rackspace.com).

It will be appreciated that while the foregoing provides one example of how the present invention could be implemented using publicly and commercially available software components, the present invention could be assembled and implemented using a variety of different software designs readily apparent to web designers and software engineers. Further, while the invention has been described in one particular embodiment above, the present invention could also take the form of a variety of other embodiments

We claim:

1. A server computing system having at least one processor and a memory and being part of a distributed computing system including at least one client computing system, the server computing system providing content service to a plurality of users and the server computing system executing instructions to send a variety of content segments from the server computing system to a client computing system; to receive in one or more selected content segments from the client computing system; to filter a plurality of advertising segments to create a variety of advertising segments matching user preselected criteria; to send the variety of advertising segments from the server computing system to the client computing system; to receive one or more selected advertising segments from the client computing system; and to assemble the selected content segments and the selected advertising segments for display in a customized content view for the user.

2. A server computing system according to claim 1, wherein content segments includes video or audio clips.

3. A server computing system according to claim 1, wherein preselected user criteria includes user preferences.

4. A server computing system according to claim 4, wherein user preferences includes a user's choice of advertisements it is interested in.

5. A method of providing a content service to a plurality of users and being at least partially implemented on a distributed computing system having at least one server computing system and at least one client computing system, the method comprising:
sending a variety of content segments from the server computing system to the client computing system;
receiving in the server computing system one or more selected content segments from the client computing system;
filtering in the server computing system a plurality of advertising segments to create a variety of advertising segments matching user preselected criteria;
sending the variety of advertising segments from the server computing system to the client computing system;
receiving in the server computing system one or more selected advertising segments from the client computing system; and
assembling the selected content segments and the selected advertising segments for display in a customized content view for the user;
wherein the user can selected from the variety of content segments and the variety of advertising segments to create the user's own customized display of assembled content and advertising.

6. A method according to claim 5, wherein content segments includes video or audio clips.

7. A method according to claim 5, further comprising:
determining if a number of selected content segments and a number of selected advertising segments match a predetermined criteria.

8. A method according to claim 5, wherein preselected user criteria includes user preferences.

9. A method according to claim 8, wherein user preferences includes a user's choice of advertisements it is interested in.

10. A method according to claim 5, further comprising:
prior to sending a variety of content segments, filtering a plurality of content segments to create a variety of content segments matching preselected user criteria.

11. A method according to claim 10, wherein preselected user criteria includes user preferences.

12. A method of providing content service to a user and being at least partially implemented on a computing system, the method comprising:
sending a variety of content segments to a user for selection;
receiving selected content segments from the user;
sending a variety of advertising segments to the user for selection;
receiving selected advertising segments from the user; and
assembling the selected content segments and the selected advertising segments into a customized view for the user.

13. A method according to claim 12, wherein content segments includes video or audio clips.

14. A method according to claim 12, wherein advertising segments includes advertisement clips.

15. A method according to claim 14, wherein advertising clips includes video or audio clips.

16. A method according to claim 12, further comprising:
determining if the number of selected content segments and the number of selected advertising segments match a predetermined criteria.

17. A method according to claim 12, further comprising:
prior to sending a variety of advertising segments, filtering a plurality of advertising segments to create a variety of advertising segments matching preselected criteria.

18. A method according to claim 17, wherein preselected criteria includes user preferences.

19. A method according to claim 18, further comprising:
prior to sending a variety of content segments, filtering a plurality of content segments to create a variety of content segments matching preselected criteria.

20. A method according to claim 19, wherein preselected criteria includes user preferences.
